(19) United States
(12) Patent Application Publication
(10) Pub. No.: US 2026/0227019 A1
(43) Pub. Date: Aug. 6, 2026

(54) DEVICE FOR HEATING A FEEDSTOCK

(71) Applicants: BASF SE, Ludwigshafen am Rhein (DE); LINDE GMBH, Pullach (DE); SABIC GLOBAL TECHNOLOGIES B.V., Bergen op Zoom (NL)

(72) Inventors: Werner STILL, Ludwigshafen am Rhein (DE); Torsten STARK, Ludwigshafen am Rhein (DE); Reiner JACOB, Ludwigshafen am Rhein (DE); Eric JENNE, Ludwigshafen am Rhein (DE); Kiara Aenne KOCHENDOERFER, Mannheim (DE); Andrey SHUSTOV, Ludwigshafen am Rhein (DE); Grigorios KOLIOS, Ludwigshafen am Rhein (DE)

(21) Appl. No.: 19/158,327

(22) PCT Filed: Feb. 20, 2024
(86) PCT No.: PCT/EP2024/054265

§ 371 Date: Aug. 20, 2025

(30) Foreign Application Priority Data
Feb. 21, 2023 (EP) 23157751.1

(51) Int. Cl. F16L 53/35

(52) U.S. Cl. CPC F16L 53/35

(57) ABSTRACT

An apparatus (110) for heating a feedstock is proposed. The apparatus (110) comprises a plurality of electrically conductive pipelines (114) for accommodating the feedstock. The pipelines (114) are arranged so as to enable parallel feedstock flow. The apparatus (110) includes at least one power source and/or voltage source (126) set up to supply an electrical current to the pipelines (114) which heats the pipelines (114) by Joule heat which arises as the electrical current passes through conductive pipe material, in order to heat the feedstock. Each of the pipelines (110) has a first end (116) and a second end (118). At least one electrical insulator (132) is disposed at the first end (116) and the second end (118) such that the respective pipeline (114) and at least one supplying pipeline (120) and at least one discharging pipeline (122) are galvanically isolated from one another. The individual pipelines (114) are electrically interconnected in a series connection.

The invention relates to an apparatus for heating a feedstock and to a plant comprising an apparatus for heating a feedstock. The apparatus may especially be used for heating of feedstock to a temperature in the range from 200° C. to 1700° C., preferably from 300° C. to 1400° C., more preferably from 400° C. to 875° C. The apparatus is set up in particular for electrical heating of the feedstock, for example as an electrical furnace or part of an electrical furnace. The plant may be set up, for example, for performance of at least one endothermic reaction, a plant for heating, a plant for preheating, a steamcracker, a steam reformer, an apparatus for alkane dehydrogenation, a reformer, an apparatus for dry reforming, an apparatus for styrene production, an apparatus for ethylbenzene dehydrogenation, an apparatus for cracking of ureas, isocyanates, melamine, a cracker, a catalytic cracker, an apparatus for dehydrogenation, an apparatus for acetylene production from hydrocarbons. However, other fields of use are also conceivable.

Such apparatuses for electrical heating of a feedstock are fundamentally known. For example, WO 2015/197181 A1 describes a device for heating a fluid comprising at least one electrically conductive pipeline for accommodating the fluid, and at least one voltage source connected to the at least one pipeline. The at least one voltage source is set up to generate an alternating electrical current in the at least one pipeline, which heats the at least one pipeline in order to heat the fluid.

WO 2020/035575 describes a device for heating a fluid. The device comprises—at least one electrically conductive pipeline and/or at least one electrically conductive pipeline segment for accommodating the fluid, and—at least one DC power source and/or DC voltage source, wherein each pipeline and/or each pipeline segment is assigned a DC power source and/or DC voltage source which is connected to the respective pipeline and/or to the respective pipeline segment, wherein the respective DC power source and/or DC voltage source is designed to generate an electrical current in the respective pipeline and/or in the respective pipeline segment which heats the respective pipeline and/or the respective pipeline segment by Joule heat that arises on passage of the electrical current through conductive pipe material, in order to heat the fluid.

WO 2021/160777 A1 describes a device for heating a fluid. The device comprises—at least one electrically conductive pipeline and/or at least one electrically conductive pipeline segment to accommodate the fluid, and—at least one single-phase AC power source and/or at least one single-phase AC voltage source, each pipeline and/or each pipeline segment being assigned a single-phase AC power source and/or a single-phase AC voltage source which is connected to the respective pipeline and/or to the respective pipeline segment, the respective single-phase AC power source and/or single-phase AC voltage source being designed to generate an electrical current in the respective pipeline and/or in the respective pipeline segment, which heats the respective pipeline and/or the respective pipeline segment by Joule heat that arises on passage of the electrical current through conductive pipe material, in order to heat the fluid, the single-phase AC power source and/or the single phase AC voltage source being connected to the pipeline and/or the pipeline segment in an electrically conducting manner in such a way that the alternating current generated flows into the pipeline and/or the pipeline segment via a forward conductor and flows back to the AC power source and/or AC voltage source via a return conductor.

In spite of the numerous advantages that have been achieved with the known apparatuses and processes, numerous technical challenges still remain.

Thus, the input power per pipeline (or pipeline segment or section) in such plants for electrical heating cannot be increased arbitrarily. For example, a maximum pipeline length can be limited by a maximum dwell time. A voltage or current ratio can be determined by the resistance of the pipeline. A pipeline material cannot be optimized to the appropriate specific resistivity. The maximum applicable voltage per pipeline may thus be limited.

The maximum applicable voltage is limited to values that must be controllable, especially also in the event of a fault. Furthermore, known apparatuses have a high space and installation requirement for switchgear, cables, busbars, actuators and transformers. In particular, it is necessary to ensure voltage adjustment from several kV to <100 V over several stages.

It is therefore an object of the present invention to provide an apparatus for heating a feedstock and a plant which at least largely avoid the disadvantages of known apparatuses and processes. For this purpose, the applicable voltage should be increased as far as possible. In particular, the apparatus should be easily implementable and compact, and at the same time should ensure a high level of electrical safety.

This object is achieved by an apparatus and a plant having the features of the independent claims. Preferred configurations of the invention are specified inter alia in the associated subsidiary claims and dependency references of the subsidiary claims.

The terms “have”, “comprise” or “include” hereinafter or any grammatical variations thereof are used in a non-exclusive manner. Accordingly, these expressions may relate either to situations in which there are no further features apart from the feature introduced by these expressions or to situations in which there is or are one or more further features. For example, the expression “A has B”, “A comprises B” or “A includes B” may relate both to the situation in which, apart from B, there is no further element in A (i.e. to a situation in which A exclusively consists of B) and to the situation in which, in addition to B, there is or are one or more further elements in A, for example element C, elements C and D or even further elements.

It is also pointed out that the terms “at least one” and “one or more” and grammatical variations of these terms or similar terms, when they are used in connection with one or more elements or features and are intended to express that the element or feature may be provided one or more times, are generally only used once, for example when the feature or element is introduced for the first time. When the feature or element is subsequently mentioned again, the corresponding term “at least one” or “one or more” is generally no longer used, without restricting the possibility that the feature or element may be provided one or more times.

Furthermore, the terms “preferably”, “in particular”, “for example” or similar terms are used hereinafter in connection with optional features, without alternative embodiments being restricted thereby. Thus, features that are introduced by these expressions are optional features, and there is no intention to restrict the scope of protection of the claims, and in particular of the independent claims, by these features. Thus, as a person skilled in the art will appreciate, the invention may also be carried out using other configurations. In a similar way, features that are introduced by “in an embodiment of the invention” or by “in a working example of the invention” are considered to be optional features, without any intention thereby to restrict alternative configurations or the scope of protection of the independent claims. Furthermore, all the possible combinations of the features thereby introduced with other features, whether optional or non-optional features, shall remain unaffected by these introductory expressions.

In a first aspect of the present invention, an apparatus for heating a feedstock is proposed.

In particular, the apparatus is to be usable in a plant selected from the group consisting of: a plant for performance of at least one endothermic reaction, a plant for heating, a plant for preheating, a steamcracker, a steam reformer, an apparatus for alkane dehydrogenation, a reformer, an apparatus for dry reforming, an apparatus for styrene production, an apparatus for ethylbenzene dehydrogenation, an apparatus for cracking of ureas, isocyanates, melamine, a cracker, a catalytic cracker, an apparatus for dehydrogenation, an apparatus for acetylene production from hydrocarbons.

The apparatus comprises a plurality of electrically conductive pipelines for accommodating the feedstock. The pipelines are arranged so as to enable parallel feedstock flow. The apparatus includes at least one power source and/or voltage source set up to supply an electrical current to the pipelines which heats the pipelines by Joule heat which arises as the electrical current passes through conductive pipe material, in order to heat the feedstock. Each of the pipelines has a first end and a second end. At least one electrical insulator is disposed at the first end and the second end such that the respective pipeline and at least one supplying pipeline and at least one discharging pipeline are galvanically isolated from one another. The individual pipelines are electrically interconnected in a series connection.

The electrical series connection of the pipelines, also referred to as series connection of the pipelines, allows the electrical conductor to be extended as required, while simultaneously maintaining the process parameters through parallelization by process engineering means. This can increase the electrical resistance of the system. It is thus possible to increase the applicable voltage per series connection. The suppliable power can be increased by at least one order of magnitude. At the same time, the number of necessary voltage-reducing components can be decreased.

The expression “feedstock” as used here is a broad expression that should be attributed its usual and common meaning as understood by a person skilled in the art. This expression is not restricted to a specific or adapted meaning. This expression may, without restriction, refer in particular to basically any material that is also referred to as feed or feedstock. The feedstock may include at least one material from which reaction products can be produced and/or prepared, especially by at least one chemical reaction. The feedstock may especially be a reactant with which a chemical reaction is to be conducted. The feedstock may be liquid or gaseous. The feedstock may be a hydrocarbon to be subjected to thermal cleavage and/or a mixture. The feedstock may include at least one element selected from the group consisting of: methane, ethane, propane, butane, naphtha, ethylbenzene, gas oil, condensates, biofluids, biogases, pyrolysis oils, waste oils and liquids composed of renewable raw materials. Biofluids may, for example, be fats or oils or derivatives thereof from renewable raw materials, for example bio oil or biodiesel. Other feedstocks are also conceivable. In the context of the present invention, reference is made by way of example to fluids, in a representative manner for any of the other feedstocks listed.

The expression “heating the feedstock” as used here is a broad expression that should be attributed its usual and common meaning as understood by a person skilled in the art. This expression is not restricted to a specific or adapted meaning. The expression may, without restriction, relate in particular to an operation that leads to a change in a temperature of the feedstock, especially to a rise in the temperature of the feedstock, for example to heating of the feedstock. The feedstock can be heated electrically, especially purely electrically. The apparatus may be used as an electrical furnace. But other embodiments are also conceivable. Utilization as a hybrid furnace may also be possible, operated, for example, with gas, power, or gas and power. As stated above, the apparatus includes at least one power source and/or voltage source set up to supply an electrical current to the pipelines which heats the pipelines by Joule heat which arises as the electrical current passes through conductive pipe material, in order to heat the feedstock. The feedstock may, for example, be warmed to a defined or predetermined temperature value by the heating. The apparatus may be set up to heat the feedstock to a temperature in the range from 200° C. to 1700° C., preferably 300° C. to 1400° C., more preferably 400° C. to 875° C.

The expression “pipeline” as used here is a broad expression that should be attributed its usual and common meaning as understood by a person skilled in the art. This expression is not restricted to a specific or adapted meaning. This expression may, without limitation, refer in particular to an apparatus which has an interior delimited from an external environment by a shell surface. The expression “pipeline” here encompasses a pipe, a pipeline segment and/or a pipeline coil. The pipeline may comprise at least one pipe and/or at least one pipeline segment and/or at least one pipeline coil. A pipeline segment may be a subregion of a pipeline. The expressions “pipeline” and “pipeline segment” and “pipeline coil” are used as synonyms hereinafter. The pipelines may be configured as single pipelines, double pipelines or even multiple pipelines. In the case of double pipelines or else multiple pipelines, two or more pipelines can be supplied with the feedstock in a parallelized manner from a common supplying and a common discharging pipeline.

The pipeline may have at least a partly cylindrical section. For example, the pipeline may be configured as a hollow cylinder pipe, for example, a circular cylinder with radius r and a length h, also referred to as height. The circular cylinder may have a bore along an axis. Variances from a circular cylinder geometry are also conceivable. For example, the hollow cylinder pipe may be an elliptical cylinder. For example, the hollow cylinder pipe may be a prismatic cylinder.

The expression “accommodating the feedstock” as used here is a broad expression that should be attributed its usual and common meaning as understood by a person skilled in the art. This expression is not restricted to a specific or adapted meaning. This expression may, without limitation, refer in particular to transport of the feedstock from a first end of the pipeline to a second end of the pipeline. The geometry and/or surfaces and/or material of the pipelines may be dependent on a feedstock to be accommodated.

The pipelines may be set up to perform at least one reaction and/or heat the feedstock. The apparatus, especially the pipelines, may therefore also be referred to as reactor or furnace, especially electrical furnace. For example, the pipeline may be and/or include at least one reaction tube in which at least one chemical reaction can proceed. The geometry and/or surfaces and/or material of the pipelines may also be chosen depending on a desired reaction and/or avoidance of a particular reaction. The reaction may proceed within the pipeline and/or outside the pipeline. The reaction may be an endothermic reaction. The reaction may be a non-endothermic reaction. The reaction may be, for example, a preheating or heating operation. An “endothermic reaction” may be considered to mean a reaction in which energy, especially in the form of heat, is absorbed from the environment. In particular, the feedstock may be heated in the pipeline.

The pipelines are electrically conductive. The expression “electrically conductive”, as used here, is a broad expression that should be attributed its usual and common meaning as understood by a person skilled in the art. This expression is not restricted to a specific or adapted meaning. This expression may, without limitation, refer in particular to a property of the pipeline such that the pipeline, in particular the material of the pipeline, is set up to conduct electrical current. The pipeline may have a specific electrical resistivity of less than 10⁻¹ Ωm. Specific electrical resistivity in the context of the present invention relates to specific electrical resistivity at room temperature. The pipeline may have a specific electrical resistivity ρ of 1·10⁻⁸ Ωm≤ρ≤10⁻¹ Ωm. For example, the pipeline may have been produced from and/or include one or more metals and alloys such as copper, aluminum, iron, steel or Cr or Ni alloys, graphite, carbon, carbides, silicides. The pipeline may include at least one material selected from the group consisting of ferritic or austenitic materials. For example, the pipeline may have been produced from and/or include a CrNi alloy. For example, the pipeline may have been produced from at least one metal and have a specific electrical resistivity of 1·10⁻⁸Ω to 200·10⁻⁸ Ωm. For example, the pipeline may have been produced from metal silicide and have a specific electrical resistivity of 1·10⁻⁸Ω-200·10⁻⁸ Ωm. For example, the pipeline may have been produced from metal carbide and have a specific electrical resistivity of 20·10⁻⁸Ω-5000·10⁻⁸ Ωm. For example, the pipeline may have been produced from carbon and have a specific electrical resistivity of 50 000·10⁻⁸Ω-100 000·10⁻⁹ m. For example, the pipeline may have been produced from graphite and have a specific electrical resistivity of 5000·10⁻⁸Ω-100 000·10⁻⁸ Ωm. For example, the pipeline may have been produced from boron carbide and have a specific electrical resistivity of 10⁻¹-10⁻².

The apparatus comprises a plurality of electrically conductive pipelines. The apparatus may have I pipelines, where I is a natural number greater than or equal to two. For example, the apparatus may comprise at least two, three, four, five or more pipelines. The apparatus may have, for example, up to one hundred pipelines. The pipelines may be configured identically or differently. The pipelines may be configured differently with regard to diameter and/or length and/or geometry.

The pipelines may comprise symmetrical and/or unsymmetrical pipes and/or combinations thereof. The geometry and/or surfaces and/or material of the pipelines may be dependent on the feedstock or else dependent on an optimization of the reaction or other factors. In a purely symmetrical configuration, the apparatus may comprise pipelines of an identical pipe type. “Unsymmetrical pipes” and “combinations of symmetrical and unsymmetrical pipes” may be considered to mean that the apparatus can have any combination of pipe types. A “pipe type” may be considered to mean one category or type of pipeline characterized by particular features. The pipe type may be characterized at least by one feature selected from the group consisting of: a horizontal configuration of the pipeline; a vertical configuration of the pipeline; a length in the inlet (I1) and/or outlet (I2) and/or transition (I3); a diameter in the inlet (d1) and outlet (d2) and/or transition (d3); number n of passes; length per pass; diameter per pass; geometry; surface; and material. The apparatus may comprise a combination of at least two different pipe types connected in parallel and/or in series. For example, the apparatus may comprise pipelines of different lengths in the inlet (I1) and/or outlet (12) and/or transition (13). For example, the apparatus may comprise pipelines with an asymmetry of the diameters in the inlet (d1) and/or outlet (d2) and/or transition (d3). For example, the apparatus may comprise pipelines with a different number of passes. For example, the apparatus may comprise pipelines with passes with different lengths per pass and/or different diameters per pass. Possible pipelines may take the form of various pipe types in the form of a construction kit and may be selected and combined as desired, dependent on an end use. Use of pipelines of different pipe types can enable more accurate temperature control and/or adjustment of the reaction when the feed is fluctuating and/or a selective yield of the reaction and/or an optimized methodology. The pipelines may comprise identical or different geometries and/or surfaces and/or materials.

The pipelines are arranged so as to enable parallel feedstock flow. The expression “enabling parallel flow”, as used here, is a broad expression that should be attributed its usual and common meaning as understood by a person skilled in the art. This expression is not restricted to a specific or adapted meaning. This expression may, without restriction, refer in particular to parallelization of the pipelines by process engineering means. The pipelines may be arranged at least partly parallel to one another. What is meant here by “at least partly parallel” is that an overall flow direction of the feedstock through the respective pipelines is parallel to an overall flow direction of the feedstock in the other pipelines, with possible variances from a parallel arrangement in some regions of the respective pipeline. For example, the pipelines may be arranged alongside one another. However, there may also be other possible arrangements of the pipelines in which the pipelines are arranged so as to enable parallel feedstock flow. For example, linear arrangements, W arrangements, U arrangements and circular arrangements are possible. There may be an opposing flow direction. For example, in an arrangement in which the pipelines are arranged alongside one another, inlets and outlets may be on one side.

The shape of the pipelines and/or the flow of the medium may be arbitrary in relation to the direction of electrical current. From a purely electrical engineering point of view, any shape and flow through the reaction tube may be possible. For example, within a heating line, the shape of the pipeline and the flow of the medium in relation to the direction of electrical current may be different, in particular freely selectable. A heating line may be one or more of a reaction section to be heated, a section of a pipeline to be heated, or a plurality of pipelines to be heated. The use of the electrical insulator described can make it possible to interconnect multiple pipelines into any individual heating lines. The heating lines can be interconnected in multiple rows and/or series connection into any electrical networks, for example star, triangle, open triangle, or the like, to form a heating group, in particular without affecting the process design.

The resistance of a pipeline can be defined by parameters, for example material(s), wall thickness, also called thickness, and length of the pipeline, and can determine the electrical engineering design. Specific resistivity can be defined by the material, although the possible materials are limited because of the high demands of temperature and pressure. The length of the pipeline can define the dwell time of the medium and cannot be altered arbitrarily for process engineering reasons. In most cases, the wall thickness of the pipeline can only be increased, since too low a wall thickness would lead to an unstable pipeline. As a result, the pipelines cannot be arbitrarily adapted or optimized in terms of electrical engineering and have to be interconnected into individual groups. The proposed invention can enable independence of the process engineering parameters from the electrical engineering parameters. For instance, the design of the pipelines can be optimized in terms of process engineering, in particular without any restrictions owing to electrical engineering. Electrical engineering can be optimized by combining the given parameters, i.e. in particular the resistance of the pipelines, in various electrical engineering interconnections to form optimal networks. It may thus be possible to apply a higher voltage with simultaneous reduction of the number of components required.

The pipelines may be through-connected, and hence form a pipe system for accommodating the feedstock. The term “pipe system”, as used here, is a broad term that should be attributed its usual and common meaning as understood by a person skilled in the art. This expression is not restricted to a specific or adapted meaning. This expression may, without restriction, refer in particular to an apparatus composed of at least two pipelines that are especially connected to one another. The pipe system may comprise supplying and discharging pipelines. The pipelines may be fluidically connected to supplying and discharging pipelines. The pipe system may comprise at least one inlet for accommodating the feedstock. The pipe system may comprise at least one outlet for discharging the feedstock. What is meant by “through-connected” is that the pipelines are fluidically connected to one another. Thus, the pipelines may be arranged and connected in such a way that the feedstock flows through the pipelines in parallel to one another. The pipelines may be set up to transport one feedstock in parallel. The pipelines may be set up to transport different feedstocks in parallel. In particular, the pipelines connected in parallel may have mutually different geometries and/or surfaces and/or materials for transport of different feedstocks. For the transport of one feedstock in particular, a number or all of the pipelines may be in parallel configuration, such that the feedstock can be divided among those pipelines in parallel configuration. Also conceivable is a combination of a parallel and serial arrangement of pipelines. For example, the apparatus may have a plurality of groups of pipelines through which parallel flow is possible, which in turn are in a series arrangement, especially in succession in one flow direction.

The apparatus has at least one power source and/or voltage source. The power source and/or the voltage source may comprise a single-phase or multiphase AC power source and/or single-phase or multiphase AC voltage source, or a DC power source and/or DC voltage source. The apparatus may have at least one inlet and outlet that electrically connects the power source and/or voltage source to the pipeline.

The apparatus may have, for example, at least one AC power source and/or at least one AC voltage source. The AC power source and/or an AC voltage source may be a single-phase or multiphase source. An “AC power source” may be understood to mean a power source designed to provide an alternating current. An “alternating current” may be understood to mean an electrical current of a polarity which changes in a regular repetition over time. For example, the alternating current may be a sinusoidal alternating current. A “single-phase” AC power source may be understood to mean an AC power source which provides an electrical current with a single phase. A “multiphase” AC power source may be understood to mean an AC power source which provides an electrical current with more than one phase. An “AC voltage source” may be understood to mean a voltage source set up to provide an AC voltage. An “AC voltage” may be understood as meaning a voltage of which the level and polarity are regularly repeated over time. For example, the AC voltage may be a sinusoidal AC voltage. The voltage generated by the AC voltage source causes a current to flow, in particular an alternating current to flow. A “single-phase” AC voltage source may be understood to mean an AC voltage source which provides the alternating current with a single phase. A “multiphase” AC voltage source may be understood to mean an AC voltage source which provides the alternating current with more than one phase.

The apparatus may have at least one DC power source and/or at least one DC voltage source. A “DC power source” may be understood to mean an apparatus set up to provide a DC current. A “DC voltage source” may be understood to mean an apparatus set up to provide a DC voltage. The DC power source and/or DC voltage source may be set up to generate a DC current in the pipeline. “DC current” may be understood to mean an electrical current that is substantially constant in terms of strength and direction. “DC voltage” may be understood to mean a substantially constant electrical voltage. “Substantially constant” may be understood to mean a current or a voltage having variations that are immaterial in respect of the intended effect.

The apparatus may have a multitude of power sources and/or voltage sources, said power sources and/or voltage sources being selected from the group consisting of: single-phase or multiphase AC power sources and/or single-phase or multiphase AC voltage sources or DC power sources and/or DC voltage sources, and a combination thereof. The apparatus may have 2 to M different power sources and/or voltage sources, where M is a natural number not less than three. The power sources and/or voltage sources may be configured with or without the possibility of controlling at least one electrical output variable. The power sources and/or voltage sources may be electrically controllable independently of one another. The power sources and/or voltage sources may be of identical or different configuration. For example, the apparatus may be set up such that current and/or voltage are adjustable for different zones, especially heating zones, of the apparatus. The pipelines may be-long to different temperature regions or zones. The pipelines themselves may likewise have temperature zones. The individual pipelines may be assigned one or more power sources or voltage sources. The power supply and/or voltage supply may, for example, be adjusted by use of at least one controller, in each case depending on the reaction and methodology. Using a multitude of power sources and/or voltage sources allows the voltage in particular to be varied for different zones. For instance, it is possible to achieve not too high a current, which would result in excessively hot pipelines, or, conversely, excessively cold pipelines.

The power source and/or voltage source has been set up to apply an electrical current to the pipelines. The expression “apply”, as used here, is a broad expression that should be attributed its usual and common meaning as understood by a person skilled in the art. This expression is not restricted to a specific or adapted meaning. This expression may, without limitation, refer in particular to one or more of feeding, supplying and charging.

The power source and/or voltage source may have an adjustable setup in order to feed a current corresponding to the power required. The apparatus may have at least one temperature sensor set up to determine a temperature of at least one of the pipelines. The temperature sensor may comprise an electrical or electronic element set up to generate an electrical signal as a function of temperature. For example, the temperature sensor may have at least one element selected from the group consisting of: a high-temperature conductor, a low-temperature conductor, a semiconductor temperature sensor, a temperature sensor with an oscillating crystal, a thermocouple, a pyroelectric material, a pyrometer, a thermal imaging camera, a ferromagnetic temperature sensor, a fiber-optical temperature sensor. The temperature may be measured at the input and output of the feedstock in and/or on the pipeline. For example, it is possible to make measurements at several points in the pipeline in order to determine the temperature over the length of the reactor and to match it to an optimal process regime. Closed-loop control in respect of temperature can be effected by means of at least one closed-loop control element. This can switch off the supply of power or voltage, for example, in the event of a hotspot. When the temperature is too low, the closed-loop control can increase the supply of power or voltage. The temperature sensor may be connected to the closed-loop controller by a remote connection or a fixed connection. The closed-loop controller may be connected to the power source or voltage source by a remote connection or a fixed connection. The apparatus may have at least one control unit set up to control the power source or voltage source by closed-loop control as a function of a temperature measured by the temperature sensor or an equivalent measurement parameter. What may be generally meant here by a “control unit” is an electronic apparatus set up to control at least one element of the apparatus by open-loop and/or closed-loop control. For example, the control unit may be set up to evaluate signals generated by the temperature sensor and to control the power source or voltage source by closed-loop control as a function of the temperature measured. For example, for this purpose, one or more electronic connections may be provided between the temperature sensor and the control unit. The control unit may comprise, for example, at least one data processing device, for example at least one computer or microcontroller. The data processing device may have one or more volatile and/or nonvolatile memory elements, in which case the data processing device may, for example, be programmed to actuate the temperature sensor. The control unit may also comprise at least one interface, for example an electronic interface and/or a human-machine interface, for example an input/output apparatus such as a display and/or a keyboard. The control unit may be built, for example, in a centralized or else decentralized manner. Other configurations are also conceivable. The control unit may include at least one A/D converter. The apparatus may be set up for an online temperature measurement. An “online temperature measurement” in the context of the present invention may be understood to mean a measurement of the temperature by the at least one temperature sensor which is made during the transport and/or the reaction of the feedstock in the pipeline. For instance, closed-loop control of the temperature during operation is possible. In particular, a temperature measurement and closed-loop control can be effected over a length of the reactor.

Each of the pipelines has a first end and a second end. The expression “end” of the pipeline as used here is a broad expression that should be attributed its usual and common meaning as understood by a person skilled in the art. This expression is not restricted to a specific or adapted meaning. This expression may, without restriction, refer in particular to an inlet or an outlet. At least one electrical insulator is disposed at the first end and the second end such that the respective pipeline and at least one supplying pipeline and at least one discharging pipeline are galvanically isolated from one another. The apparatus may have a plurality of electrical insulators. Galvanic isolation between the respective pipelines and the supplying and discharging pipelines can be ensured by the electrical insulators. The expression “galvanically isolated from one another”, as used here, is a broad expression that should be attributed its usual and common meaning as understood by a person skilled in the art. This expression is not restricted to a specific or adapted meaning. This expression may, without limitation, refer in particular to a separation of the pipeline and the supplying and discharging pipelines in such a way that no electrical conduction and/or tolerable electrical conduction takes place between the pipelines and the supplying and discharging pipelines.

The expression “electrical insulator” of the pipeline, as used here, is a broad expression that should be attributed its usual and common meaning as understood by a person skilled in the art. This expression is not restricted to a specific or adapted meaning. This expression may, without restriction, refer in particular to a nonconductor or a poor conductor. The electrical insulator may provide electrical insulation. The electrical insulator may have a minimum overall resistance of 100 kΩ to 1000 MΩ for the respective electrical system, preferably of 300 kΩ to 300 MΩ, more preferably of 1 MΩ to 100 MΩ, at 900° C., where the electrical system in question is the power supply module in each case. For example, the electrical insulator may have a minimum overall resistance of 300 kΩ at 900° C. for the respective electrical system.

The electrical insulator may be set up to provide electrical insulation in a high temperature range, in particular at temperatures between 500-1400° C. The electrical insulator may be configured to be stable to thermal cycling in accordance with DIN EN 993-11.

The electrical insulator can provide a free flow of the feedstock. The electrical insulator at the first end may be set up to provide a flow of the feedstock from a supplying pipeline to the pipeline. The electrical insulator at the second end may be set up to provide a flow of the feedstock from the pipeline to a discharging pipeline. The electrical insulator may be set up to provide a fluidic connection between the first end of the pipeline and a supplying pipeline. The electrical insulator may be set up to provide a fluidic connection between the second end of the pipeline and a discharging pipeline.

In known insulators, a problem with regard to permanent integrity may occur, especially when the materials differ in terms of their coefficients of thermal expansion, for example in a composite of ceramic and metal with different coefficients of thermal expansion. The electrical insulator of the invention may be set up to ensure a negligible or even zero pressure drop in the apparatus. The electrical insulator may be set up to provide a pressure drop-free, also referred to as leak-free, fluidic connection within a pressure range from 0 to 50 bar, in particular from 0 to 10 bar, where “pressure drop-free” means a negligible pressure drop or zero pressure drop. The electrical insulator may be resistant to pressure differentials up to about 100 bar. For example, the electrical insulator may be stable at an absolute pressure of 300 mbar to 100 bar, preferably 1 bar to 50 bar, more preferably from 1.5 bar to 30 bar.

The electrical insulator may include at least one suitable material that meets the conditions mentioned. For example, the electrical insulator may include at least one material selected from the group consisting of ceramic materials, vitreous materials, glassfiber-reinforced materials, plasticlike materials or resinous materials. The electrical insulator may include, for example, at least one mixture selected from the group consisting of: binary and ternary mixtures of aluminum oxide, zirconium oxide and yttrium oxide (e.g. zirconium oxide-reinforced aluminum oxide); mixtures of silicon carbide and aluminum oxide; mixtures of aluminum oxide and magnesium oxide (MgO spinel); mixtures of aluminum oxide and silicon oxide (mullite); mixture of aluminum silicates and magnesium silicates, ternary mixture of aluminum oxide, silicon oxide and magnesium oxide (cordierite); steatite (magnesium silicate); zirconium oxide-reinforced aluminum oxide; stabilized zirconium oxide (ZrO₂): stabilizers in the form of magnesium oxide (MgO), calcium oxide (CaO) or yttrium oxide (Y₂O₃), optionally other stabilizers used also include cerium oxide (CeO₂), scandium oxide (ScO₃) or ytterbium oxide (YbO₃); and also aluminum titanate (stoichiometric mixture of aluminum oxide and titanium oxide); silicon nitride and aluminum oxide (silicon aluminum oxynitride SIALON).

Zirconium oxide-reinforced aluminum oxide used is advantageously Al₂O₃ with 10 to 20 mol % of ZrO₂. ZrO₂ can advantageously be stabilized using 10 to 20 mol % of CaO, preferably 16 mol %, 10 to 20 mol % of MgO, preferably 16, or 5 to 10 mol % of Y₂O₃, preferably 8 mol % (“fully stabilized zirconium oxide”), or 1 to 5 mol % of Y₂O₃, preferably 4 mol % (“partly stabilized zirconium oxide”). An advantageous ternary mixture is, for example, 80% Al₂O₃, 18.4% ZrO₂ and 1.6% Y₂O₃.

The electrical insulator may be set up to prevent rises in potential and leakage currents on the pipeline. This means that the supply voltage of the pipelines can be chosen without taking account of unwanted potentials and leakage currents on metallic parts of the plant outside a heating region of the apparatus. For example, the supply voltage in the low voltage range may be up to about 1000 V. For example, the supply voltage in the medium voltage range may be >1 kV to about 30 kV.

The individual pipelines are electrically interconnected in a series connection. The expression “series connection”, as used here, is a broad expression that should be attributed its usual and common meaning as understood by a person skilled in the art. This expression is not restricted to a specific or adapted meaning. The term may, without restriction, refer in particular to an electrical series connection of the pipeline in a circuit. For example, an electrical connection between the pipelines may be provided. The power source and/or voltage source may be connected, for example, to a first pipeline which is series-connected to the further pipelines by electrical connections. The supplying pipeline and the discharging pipeline may be galvanically isolated by the electrical insulators, as described above, from the process-engineering pipelines (or those for parallel feedstock flow) that are interconnected in series. The apparatus may comprise a plurality of pipelines interconnected in series. Through use of the electrical insulators, the number of pipelines connected in series may in principle be as desired. For example, about 5 pipelines may be interconnected in series, especially in the case of the low-voltage range. For example, it is correspondingly even possible to interconnect up to 150 pipelines in series for 30 kV.

The present invention proposes an improvement of known plant designs of electrical furnaces with regard to an increase in a registered power and at the same time a reduction of space and installation requirements for switchgear, transformers, etc. This is possible through a combination of process-engineering parallelization of the pipeline and a series electrical interconnection of the pipelines using galvanic insulators. Without galvanic insulation, a maximum applicable voltage is limited to low values, which must be controllable even in the event of a fault. The use of electrical insulators that are suitable in terms of process engineering and mechanics now enables an increase in the applicable voltage, for example by one order of magnitude. This increase in voltage is effected with electrical serialization of the pipeline, and this type of interconnection allows a reduction in space and installation requirements. Process-engineering parallelization can further enable short dwell times and thus lead to high selectivity and yield of components of value. WO 2021/160777 A1 does not describe electrical serialization of the pipelines on page 16 lines 5 to 13. There is thus no disclosure of a combination of process-engineering parallelization of the pipeline and a series electrical interconnection of the pipelines. Such a combination enables the optimization mentioned of the known plant design of electrical furnaces.

In a further aspect, in the context of the present invention, a plant comprising an apparatus of the invention is proposed. The plant may have a plurality of apparatuses. The apparatuses may be electrically interconnected in series and/or parallel to one another. With regard to the configuration of the plant, reference is made to the description of the apparatus further up or down.

The system comprises at least one apparatus of the invention and at least one power supply module. The power supply module has at least one voltage adjuster set up to transform a medium or high mains input voltage corresponding to the power requirement to an output voltage usable by the apparatus and to provide the power source and/or voltage source.

The expression “power supply module”, as used here, is a broad expression that should be attributed its usual and common meaning as understood by a person skilled in the art. This expression is not restricted to a specific or adapted meaning. The term may, without restriction, refer in particular to a unit of the plant which is set up to provide an output voltage usable by the power source and/or voltage source of the apparatus. The power supply module may be set up to receive a medium or high mains input voltage and to transform it to the necessary output voltage. The power supply module may include at least one three-phase regulator and/or adjustable rectifier with at least one transformer and/or one variable transformer. For example, the power supply module may have a medium voltage transformer and a thyristor assembly. For example, for a 12 MW low voltage, the power supply module may have a 10 kV/950 V, 12 MVA MS transformer and a thyristor assembly. Compared to known power supply apparatuses, the power supply module of the invention can thus have a reduced number of electrical components. For example, the medium or high mains input voltage can be supplied by cable from a further-removed switchgear. Each apparatus in the plant may be assigned a power supply module. However, other configurations are also possible. In particular, reducing the number of components required allows the power supply module to be of compact configuration. The power supply module may have a height h of 2 m≥h≥5 m, a width b of 4 m≥b≥7 m and a depth t of 2 m≥t≥5 m. The power supply module may be disposed in an outdoor setting in the immediate vicinity of the apparatus or on the furnace.

The plant may be selected from the group consisting of: a plant for performance of at least one endothermic reaction, a plant for heating, a plant for preheating, a steamcracker, a steam reformer, an apparatus for alkane dehydrogenation, a reformer, an apparatus for dry reforming, an apparatus for styrene production, an apparatus for ethylbenzene dehydrogenation, an apparatus for cracking of ureas, isocyanates, melamine, a cracker, a catalytic cracker, an apparatus for dehydrogenation, an apparatus for acetylene production from hydrocarbons.

The apparatus and the plant have a multitude of advantages over known apparatuses. Parallelization of the process-engineering pipelines can enable short dwell times and hence high selectivity and/or yield of components of value. A series circuit of pipelines in terms of process engineering, by contrast, would have the disadvantage of poor yields and selectivities. Electrical series connection can enable high voltages (>>690 V rather than ~100 V).

The present invention can enable an increase in the applicable voltage and hence the applicable power by one order of magnitude. Furthermore, it is possible to enable less electrical equipment, resource conservation (fewer Cu rails), increased availability, since there is less equipment with potential faults, cost efficiency, and a reduction in the space required for transformers in plants.

In summary, in the context of the present invention, particular preference is given to the following embodiments:
Embodiment 1 An apparatus for heating a feedstock, wherein the apparatus comprises a plurality of electrically conductive pipelines for accommodating the feedstock, wherein the pipelines are arranged so as to enable parallel feedstock flow, wherein the apparatus includes at least one power source and/or voltage source set up to supply an electrical current to the pipelines which heats the pipelines by Joule heat which arises as the electrical current passes through conductive pipe material, in order to heat the feedstock, wherein each of the pipelines has a first end and a second end, wherein at least one electrical insulator is disposed at the first end and the second end such that the respective pipeline and at least one supplying pipeline and at least one discharging pipeline are galvanically isolated from each other, wherein the individual pipelines are electrically interconnected in a series connection.
Embodiment 2 The apparatus according to the preceding embodiment, wherein the apparatus is set up to heat the feedstock to a temperature in the range from 200° C. to 1700° C., preferably 300° C. to 1400° C., more preferably 400° C. to 875° C.
Embodiment 3 The apparatus according to either of the preceding embodiments, wherein the apparatus has at least one temperature sensor set up to determine a temperature of at least one of the pipelines, where the apparatus has at least one control unit set up to control the power source or voltage source by closed-loop control as a function of a temperature measured by the temperature sensor or an equivalent measurement parameter.
Embodiment 4 The apparatus according to any of the preceding embodiments, wherein the power source and/or voltage source comprises a single-phase or multiphase AC power source and/or a single-phase or multiphase AC voltage source, or a DC power source and/or DC voltage source.
Embodiment 5 The apparatus according to the preceding embodiment, wherein the power source and/or voltage source is adjustable in order to feed a current corresponding to the required power.
Embodiment 6 The apparatus according to any of the preceding embodiments, wherein the electrical insulator includes at least one material selected from the group consisting of ceramic materials, vitreous materials, glassfiber-reinforced materials, plasticlike materials or resinous materials.
Embodiment 7 The apparatus according to the preceding embodiment, wherein the electrical insulator has a minimum overall resistance for the respective electrical system of 100 kΩ to 1000 MΩ, preferably of 300 kΩ to 300 MΩ, more preferably of 1 MΩ to 100 MΩ, at 900° C.
Embodiment 8 The apparatus according to any of the preceding embodiments, wherein the pipelines have symmetrical or unsymmetrical pipes and/or a combination thereof, and/or wherein the pipelines are configured differently with regard to diameter, and/or length, and/or geometry.
Embodiment 9 The apparatus according to any of the preceding embodiments, wherein the pipelines are fluidically connected to the supplying and discharging pipelines.
Embodiment 10 The apparatus according to any of the preceding embodiments, wherein the pipelines are through-connected and thus form a pipe system for accommodating the feedstock, or wherein the pipelines are in a mutually fluidically separated configuration.
Embodiment 11 The apparatus according to any of the preceding embodiments, wherein the feedstock is a hydrocarbon to be subjected to thermal cleavage and/or a mixture.
Embodiment 12 A plant comprising at least one apparatus according to any of the preceding embodiments and at least one power supply module, wherein the power supply module has at least one voltage adjuster set up to transform a medium or high mains input voltage corresponding to the power requirement to an output voltage usable by the apparatus and to provide the power source and/or voltage source.
Embodiment 13 The plant according to the preceding embodiment, wherein the plant comprises a plurality of apparatuses.
Embodiment 14 The plant according to the preceding embodiment, wherein the apparatuses are electrically interconnected to one another in series and/or parallel.
Embodiment 15 The plant according to either of the two preceding embodiments, wherein each apparatus has a dedicated power supply module.
Embodiment 16 The plant according to any of the preceding embodiments, wherein the power supply module has a height h of 2 m≥h≥5 m, a width b of 4 m≥b≥7 m and a depth t of 2 m≥t≥5 m.
Embodiment 17 The plant according to any of the preceding embodiments, wherein the plant is selected from the group consisting of: a plant for performance of at least one endothermic reaction, a plant for heating, a plant for preheating, a steamcracker, a steam reformer, an apparatus for alkane dehydrogenation, a reformer, an apparatus for dry reforming, an apparatus for styrene production, an apparatus for ethylbenzene dehydrogenation, an apparatus for cracking of ureas, isocyanates, melamine, a cracker, a catalytic cracker, an apparatus for dehydrogenation, an apparatus for acetylene production from hydrocarbons.

### BRIEF DESCRIPTION OF THE FIGURES

Further details and features of the invention will be apparent from the description of preferred working examples that follows, in particular in conjunction with the subsidiary claims. The respective features may in this case be implemented on their own, or two or more may be implemented in combination with one another. The invention is not restricted to the working examples. The working examples are illustrated diagrammatically in the figures.

Identical reference numerals in the individual figures relate to elements that are the same or have the same function, or correspond to one another in expressions of their functions.

The individual figures show:

FIG. 1 one embodiment of the apparatus of the invention;

FIG. 2 a further embodiment of the apparatus of the invention;

FIGS. 3A to 3C further embodiments of the apparatus of the invention;

FIG. 4 one embodiment of the plant of the invention; and

FIG. 5 an example of a connection of a pipeline and an electrical insulator.

### WORKING EXAMPLES

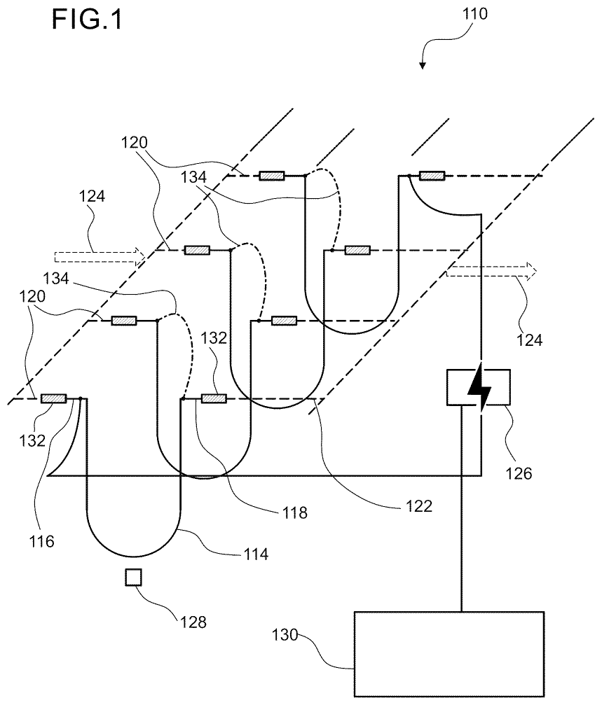

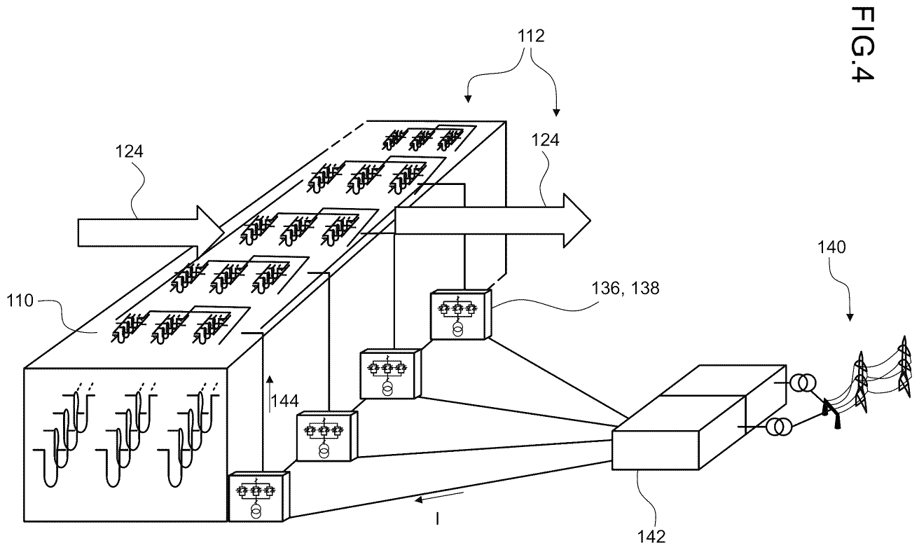

FIG. 1 shows a schematic diagram of a working example of an inventive apparatus 110 for heating a feedstock. In particular, the apparatus 110 is to be usable in a plant 112, for example in a plant shown in FIG. 4. The plant 112 may be selected from the group consisting of: a plant for performance of at least one endothermic reaction, a plant for heating, a plant for preheating, a steamcracker, a steam reformer, an apparatus for alkane dehydrogenation, a reformer, an apparatus for dry reforming, an apparatus for styrene production, an apparatus for ethylbenzene dehydrogenation, an apparatus for cracking of ureas, isocyanates, melamine, a cracker, a catalytic cracker, an apparatus for dehydrogenation, an apparatus for acetylene production from hydrocarbons.

The feedstock may be fundamentally any material. The feedstock may include at least one material from which reaction products can be produced and/or prepared, especially by at least one chemical reaction. The feedstock may especially be a reactant with which a chemical reaction is to be conducted. The feedstock may be liquid or gaseous. The feedstock may be a hydrocarbon to be subjected to thermal cleavage and/or a mixture. The feedstock may include at least one element selected from the group consisting of: methane, ethane, propane, butane, naphtha, ethylbenzene, gas oil, condensates, biofluids, biogases, pyrolysis oils, waste oils and liquids composed of renewable raw materials. Biofluids may, for example, be fats or oils or derivatives thereof from renewable raw materials, for example bio oil or biodiesel. Other feedstocks are also conceivable. In the context of the present invention, reference is made by way of example to fluids, in a representative manner for any of the other feedstocks listed.

The heating of the feedstock may comprise a change in a temperature of the feedstock, especially a rise in the temperature of the feedstock, for example to heating of the feedstock. The feedstock may, for example, be warmed to a defined or predetermined temperature value by the heating. The apparatus 110 may be set up to heat the feedstock to a temperature in the range from 200° C. to 1700° C., preferably 300° C. to 1400° C., more preferably 400° C. to 875° C. The feedstock can be heated electrically, especially purely electrically. The apparatus may be used as an electrical furnace. But other embodiments are also conceivable. Utilization as a hybrid furnace may also be possible, operated, for example, with gas, power, or gas and power.

The apparatus 110 comprises a plurality of electrically conductive pipelines 114 for accommodating the feedstock. The pipelines 114 are arranged so as to enable parallel feedstock flow. The pipeline 114 may comprise at least one pipe and/or at least one pipeline segment and/or at least one pipeline coil. A pipeline segment may be a subregion of a pipeline. The pipeline 114 may be set up for transportation of the feedstock from a first end 116 of the pipeline 114 to a second end 118 of the pipeline 114. The geometry and/or surfaces and/or material of the pipelines may be dependent on a feedstock to be accommodated.

The pipelines 114 may be set up to perform at least one reaction and/or heat the feedstock. The apparatus 110, especially the pipelines 114, may therefore also be referred to as reactor or furnace, especially electrical furnace. For example, the pipeline 114 may be and/or include at least one reaction tube in which at least one chemical reaction can proceed. The geometry and/or surfaces and/or material of the pipelines may also be chosen depending on a desired reaction and/or avoidance of a particular reaction. The reaction may proceed within the pipeline 114 and/or outside the pipeline 114. The reaction may be an endothermic reaction. The reaction may be a non-endothermic reaction. The reaction may be, for example, a preheating or heating operation. In particular, the feedstock may be heated in the pipeline 114.

The pipelines 114 are electrically conductive. The pipeline 114 may have a specific electrical resistivity of less than 10⁻¹ Ωm. Specific electrical resistivity in the context of the present invention relates to specific electrical resistivity at room temperature. The pipeline 114 may have a specific electrical resistivity ρ of 1·10⁻⁸ Ωm≤ρ≤10⁻¹ Ωm. For example, the pipeline 114 may have been produced from and/or include one or more metals and alloys such as copper, aluminum, iron, steel or Cr or Ni alloys, graphite, carbon, carbides, silicides. The pipeline 114 may include at least one material selected from the group consisting of ferritic and austenitic materials. For example, the pipeline may have been produced from and/or include a CrNi alloy. For example, the pipeline may have been produced from at least one metal and have a specific electrical resistivity of 1·10⁻⁸Ω to 200·10⁻⁸ Ωm. For example, the pipeline 114 may have been produced from metal silicide and have a specific electrical resistivity of 1·10⁻⁸Ω-200·10⁻⁸ Ωm. For example, the pipeline 114 may have been produced from metal carbide and have a specific electrical resistivity of 20·10⁻⁸Ω-5000·10⁻⁸ Ωm. For example, the pipeline 114 may have been produced from carbon and have a specific electrical resistivity of 50 000·10⁻⁸Ω-100 000·10⁻⁸ Ωm. For example, the pipeline 114 may have been produced from graphite and have a specific electrical resistivity of 5000·10⁻⁸Ω-100 000·10⁻⁸ Ωm. For example, the pipeline 114 may have been produced from boron carbide and have a specific electrical resistivity of 10⁻¹-10⁻².

The apparatus 110 comprises a plurality of electrically conductive pipelines 114. The apparatus 110 may have I pipelines 114 where I is a natural number not less than two. For example, the apparatus 110 may comprise at least two, three, four, five or more pipelines 114. The apparatus 110 may for example comprise up to one hundred pipelines 114. The pipelines 114 may be of identical or different configuration. The pipelines 114 may be configured differently with regard to diameter, and/or length, and/or geometry.

The pipelines 114 are arranged so as to enable parallel feedstock flow. The pipelines 114 may be arranged at least partly parallel to one another. An overall flow direction of the feedstock through the respective pipelines 114 may be parallel to an overall flow direction of the feedstock in the other pipelines 114, with possible variances from a parallel arrangement in some regions of the respective pipeline 114.

The pipelines 114 may be through-connected, and hence form a pipe system for accommodating the feedstock. The pipe system may comprise supplying and discharging pipelines 120, 122. A process direction (here identical to the overall flow direction) is indicated by the arrows 124. The pipelines 114 may be fluidically connected to supplying and discharging pipelines 120, 122. The pipe system may comprise at least one inlet for accommodating the feedstock. The pipe system may comprise at least one outlet for discharging the feedstock. The pipelines 114, 120, 122 are fluidically connected to one another. For instance, the pipelines 114 may be arranged and connected in such a way that the feedstock flows through the pipelines in parallel to one another. The pipelines 114 may be arranged so as to transport a feedstock in parallel. The pipelines 114 may be set up to transport different feedstocks in parallel. In particular, the pipelines 114 connected in parallel may have mutually different geometries and/or surfaces and/or materials for transport of different feedstocks. For the transport of one feedstock in particular, a number or all of the pipelines 114 may be in parallel configuration, such that the feedstock can be divided among those pipelines in parallel configuration. Also conceivable is a combination of a parallel and serial arrangement of pipelines 114. For example, the apparatus may have a plurality of groups of pipelines 114 through which parallel flow is possible, which in turn are in a series arrangement, especially in succession in one flow direction.

The apparatus 110 includes at least one power source and/or voltage source 126 set up to supply an electrical current to the pipelines 114 which heats the pipelines 114 by Joule heat which arises as the electrical current passes through conductive pipe material, in order to heat the feedstock. FIG. 1 shows the power source and/or voltage source 126 in purely schematic form. The power source and/or the voltage source 126 may comprise a singlephase or multiphase AC power source and/or single-phase or multiphase AC voltage source, or a DC power source and/or DC voltage source. The apparatus 110 may have at least one inlet and outlet that electrically connects the power source and/or voltage source 126 to the pipeline 114.

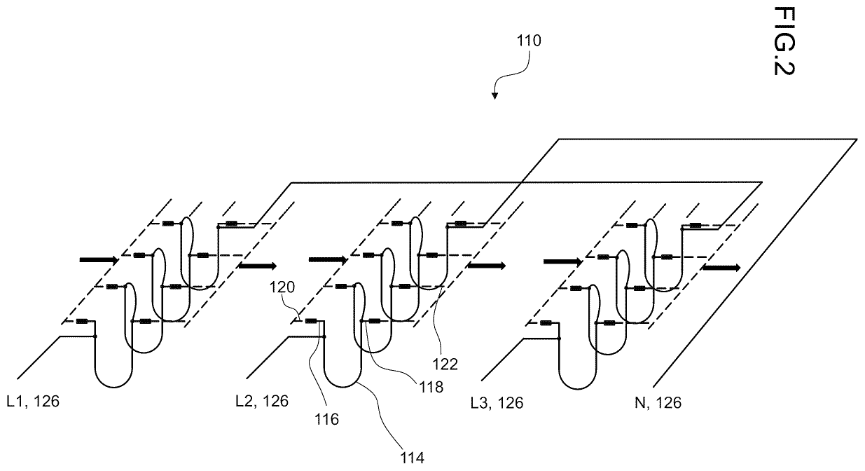

FIG. 2 shows, by way of example, a working example in which the power source and/or voltage source 126 may be a multi-phase AC power source and/or multi-phase AC voltage source. Three groups of pipelines 114 arranged in series are shown, with the pipelines 114 in the respective groups arranged parallel to the feedstock flow. The three outside conductors are labeled L1, L2 and L3, and the neutral conductor N. Also conceivable is a multi-phase AC power source or AC voltage source with nx3 conductors. For further description of FIG. 2, reference is made to the description of FIG. 1.

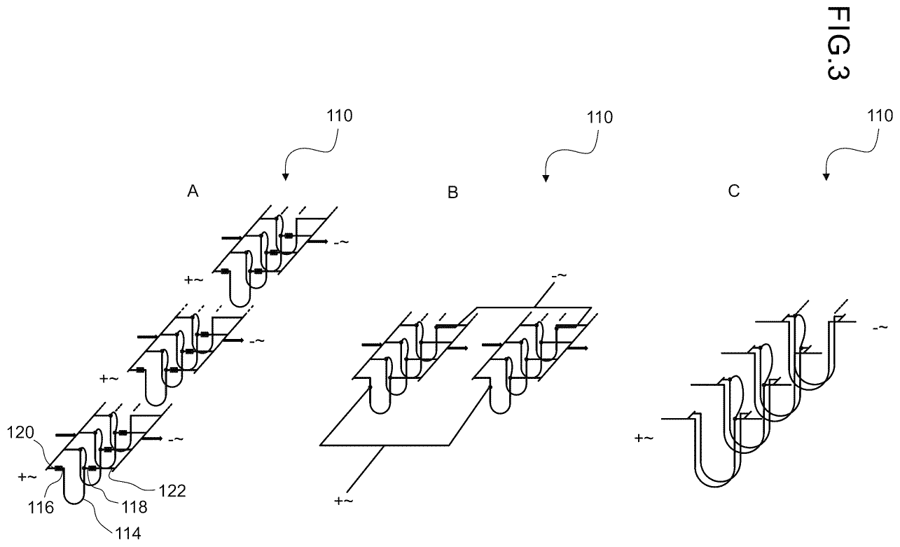

FIG. 3 shows further working examples with further electrical engineering switching options of the pipelines 114 and groups of pipelines 114. FIG. 3A shows an individual supply of the groups of parallel pipelines. FIG. 3B shows a working example in which the groups of pipelines are supplied in parallel. The pipelines are configured as individual pipelines. FIG. 3C shows a working example in which the individual pipelines are supplied in parallel. The pipelines are designed as double pipelines. The power source and/or voltage source 126 may be respectively designed as a DC power source and/or DC voltage source or as an AC power source and/or AC voltage source.

The power source and/or voltage source 126 may have an adjustable setup in order to feed a current corresponding to the power required. As shown schematically in FIG. 1, the apparatus 110 may have at least one temperature sensor 128 set up to determine a temperature of at least one of the pipelines. The temperature sensor 128 may comprise an electrical or electronic element set up to generate an electrical signal as a function of temperature. For example, the temperature sensor 128 may have at least one element selected from the group consisting of: a high-temperature conductor, a low-temperature conductor, a semi-conductor temperature sensor, a temperature sensor with an oscillating crystal, a thermocouple, a pyroelectric material, a pyrometer, a thermal imaging camera, a ferromagnetic temperature sensor, a fiber-optical temperature sensor. The temperature may be measured at the input and output of the feedstock in and/or on the pipeline 114. For example, it is possible to make measurements at several points in the pipeline 114 in order to determine the temperature over the length of the reactor and to match it to an optimal process regime. Closed-loop control in respect of temperature can be effected by means of at least one closed-loop control element. This can switch off the supply of power or voltage, for example, in the event of a hotspot. When the temperature is too low, the closed-loop control can increase the supply of power or voltage. The temperature sensor 128 may be connected to the closed-loop controller by a remote connection or a fixed connection. The closed-loop controller may be connected to the power source or voltage source 126 by a remote connection or a fixed connection. The apparatus 110 may have at least one control unit 130 set up to control the power source or voltage source 126 by closed-loop control as a function of a temperature measured by the temperature sensor 128 or an equivalent measurement parameter. For example, the control unit 130 may be set up to evaluate signals generated by the temperature sensor and to control the power source or voltage source 126 by closed-loop control as a function of the temperature measured. For example, for this purpose, one or more electronic connections may be provided between the temperature sensor 128 and the control unit 130. The control unit 130 may comprise, for example, at least one data processing device, for example at least one computer or microcontroller. The data processing device may have one or more volatile and/or nonvolatile memory elements, in which case the data processing device may, for example, be programmed to actuate the temperature sensor 128. The control unit 130 may also comprise at least one interface, for example an electronic interface and/or a human-machine interface, for example an input/output apparatus such as a display and/or a keyboard. The control unit 130 may be built, for example, in a centralized or else decentralized manner. Other configurations are also conceivable. The control unit 130 may include at least one A/D converter. The apparatus 110 may be set up for an online temperature measurement. For instance, closed-loop control of the temperature during operation is possible. In particular, a temperature measurement and closed-loop control can be effected over a length of the reactor.

Each of the pipelines 114 has a first end 116 and a second end 118. At least one electrical insulator 132 is disposed at the first end 116 and the second end 118, such that the respective pipeline 114 and at least one supplying pipeline 120 and at least one discharging pipeline 122 are galvanically isolated from each other. The apparatus 110 may comprise a plurality of electrical insulators 132. Galvanic isolation between the respective pipelines 114 and the supplying and discharging pipelines 120, 122 can be ensured by the electrical insulators 132. The galvanic isolation may be such that there is no electrical conduction and/or tolerable electrical conduction between the pipelines 114 and the supplying and discharging pipelines 120, 122.

The electrical insulator 132 may be a non-conductor or a poor conductor. The electrical insulator 132 may provide electrical insulation. The electrical insulator 132 may have a minimum resistance of 100 kΩ to 1000 MΩ, preferably of 300 kΩ to 300 MΩ, more preferably of 1 MΩ to 100 MΩ, at 900° C., where the electrical system in question is the power supply module in each case. For example, the electrical insulator may have a minimum overall resistance of 300 kΩ at 900° C. for the respective electrical system.

The electrical insulator 132 may be set up to provide electrical insulation in a high temperature range, in particular at temperatures between 500-1400° C. The electrical insulator 132 may be configured to be stable to thermal cycling in accordance with DIN EN 993-11.

The electrical insulator 132 can provide a free flow of the feedstock. The electrical insulator 132 at the first end 116 may be set up to provide a flow of the feedstock from a supplying pipeline 120 to the pipeline 114. The electrical insulator 132 at the second end 118 may be set up to provide a flow of the feedstock from the pipeline 114 to a discharging pipeline 122. The electrical insulator 132 may be set up to provide a fluidic connection between the first end 116 of the pipeline 114 and a supplying pipeline 120. The electrical insulator 132 may be set up to provide a fluidic connection between the second end 118 of the pipeline 114 and a discharging pipeline 122.

In known insulators, a problem with regard to permanent integrity may occur, especially when the materials differ in terms of their coefficients of thermal expansion, for example in a composite of ceramic and metal with different coefficients of thermal expansion. The inventive electrical insulator 132 may be set up to ensure a negligible or even zero pressure drop in the apparatus. The electrical insulator 132 may be set up to provide a pressure drop-free, also referred to as leak-free, fluidic connection within a pressure range from 0 to 50 bar, in particular from 0 to 10 bar, where “pressure drop-free” means a negligible pressure drop or zero pressure drop. The electrical insulator 132 may be resistant to pressure differentials up to about 100 bar. For example, the electrical insulator may be stable at an absolute pressure of 300 mbar to 100 bar, preferably 1 bar to 50 bar, more preferably from 1.5 bar to 30 bar.

The electrical insulator 132 may include at least one suitable material that meets the conditions mentioned. For example, the electrical insulator 132 may include at least one material selected from the group consisting of ceramic materials, vitreous materials, glassfiber-reinforced materials, plasticlike materials or resinous materials. The electrical insulator may include, for example, at least one mixture selected from the group consisting of: binary and ternary mixtures of aluminum oxide, zirconium oxide and yttrium oxide (e.g. zirconium oxide-reinforced aluminum oxide); mixtures of silicon carbide and aluminum oxide; mixtures of aluminum oxide and magnesium oxide (MgO spinel); mixtures of aluminum oxide and silicon oxide (mullite); mixture of aluminum silicates and magnesium silicates, ternary mixture of aluminum oxide, silicon oxide and magnesium oxide (cordierite); steatite (magnesium silicate); zirconium oxide-reinforced aluminum oxide; stabilized zirconium oxide (ZrO₂): stabilizers in the form of magnesium oxide (MgO), calcium oxide (CaO) or yttrium oxide (Y₂O₃), optionally other stabilizers used also include cerium oxide (CeO₂), scandium oxide (ScO₃) or ytterbium oxide (YbO₃); and also aluminum titanate (stoichiometric mixture of aluminum oxide and titanium oxide); silicon nitride and aluminum oxide (silicon aluminum oxynitride SIALON).

The electrical insulator 132 may be set up to prevent rises in potential and leakage currents on the pipeline 114. This means that the supply voltage of the pipelines 114 can be chosen without taking account of unwanted potentials and leakage currents on metallic parts of the plant outside a heating region of the apparatus 110. For example, the supply voltage in the low voltage range may be up to about 1000 V. For example, the supply voltage in the medium voltage range may be >1 kV to about 30 kV.

The individual pipelines 114 are electrically interconnected in a series connection. The pipelines 114 may in particular be electrically connected in series. For example, as in FIGS. 1 to 4, an electrical connection 134 between the pipelines 114 may be provided. The power source and/or voltage source 126 may be connected, for example, to a first pipeline 114 which is series-connected to the further pipelines 114 by electrical connections 134. The supplying pipeline 120 and the discharging pipeline 122 may be galvanically isolated from the series-connected pipelines 114 by means of the electrical insulators 132, as described above. The apparatus 110 may comprise a plurality of pipelines 114 interconnected in series. Through use of the electrical insulators 132, the number of pipelines 114 connected in series may in principle be as desired. For example, about 5 pipelines 114 may be interconnected in series, especially in the case of the low-voltage range. For example, it is correspondingly even possible to interconnect up to 150 pipelines 114 in series for 30 kV.

FIG. 4 shows a schematic diagram of a working example of the inventive plant 112. The plant 112 comprises at least one inventive apparatus 110. As shown in FIG. 4, the plant 112 may comprise a plurality of apparatuses 110. The apparatuses 110 may be electrically interconnected in series and/or parallel to one another. With regard to the configuration of the apparatuses 110, reference is made to the description of FIGS. 1 to 3.

The plant 112 may be selected from the group consisting of: a plant for performance of at least one endothermic reaction, a plant for heating, a plant for preheating, a steamcracker, a steam reformer, an apparatus for alkane dehydrogenation, a reformer, an apparatus for dry reforming, an apparatus for styrene production, an apparatus for ethylbenzene dehydrogenation, an apparatus for cracking of ureas, isocyanates, melamine, a cracker, a catalytic cracker, an apparatus for dehydrogenation, an apparatus for acetylene production from hydrocarbons.

The plant 112 comprises at least one power supply module 136. The power supply module 136 has at least one voltage adjuster 138 set up to transform a medium or high mains input voltage 140 corresponding to the power requirement to an output voltage usable by the apparatus 110 and to provide the power source and/or voltage source 126.

The power supply module 136 may be set up to provide an output voltage usable by the power source and/or voltage source 126 of the apparatus 110. The power supply module 136 may be set up to receive a medium or high mains input voltage 140 and to transform it to the necessary output voltage. The power supply module 136 may include at least one three-phase regulator and/or adjustable rectifier with at least one transformer and/or one variable transformer. For example, the power supply module 136 may have a medium voltage transformer and a thyristor assembly. For example, for a 12 MW low voltage, the power supply module may have a 10 kV/950 V, 12 MVA MS transformer and a thyristor assembly. Compared to known power supply apparatuses, the inventive power supply module 136 may thus have a reduced number of electrical components. As shown in FIG. 4, each apparatus 110 may have a dedicated power supply module 136. However, there are also other conceivable embodiments in which apparatuses 110 are supplied by a common power supply module 136.

The medium or high mains input voltage 140 (for example 110 kV/10 kV, max. 40 MVA; 110 kV/20 kV, max. 80 MVA) may be provided to the power supply modules 136, for example, by cable (for example, 690 A/345 A) from a further-removed switchgear 142 (for example a medium voltage switchroom). It is possible, for example, as in FIG. 4, for 4 or even more power supply modules 136 to be assigned to each common switchgear 142.

In the example shown in FIG. 4, the power supply module 136 may have medium voltage transformer 10 kV/950 V, 12 MVA and a thyristor assembly. The power supply module 136 can then provide the power source and/or voltage source 126 of the apparatus 110 with 950 V, 7.4 kA (labeled with reference number 144).

In particular, reducing the number of components required allows the power supply module 136 to be of compact configuration. The power supply module 136 may have a height h of 2 m≥h≥5 m, a width b of 4 m≥b≥7 m and a depth t of 2 m≥t≥5 m. The power supply module 136 may be disposed in an outdoor setting in the immediate vicinity of the apparatus 110 or on the furnace.

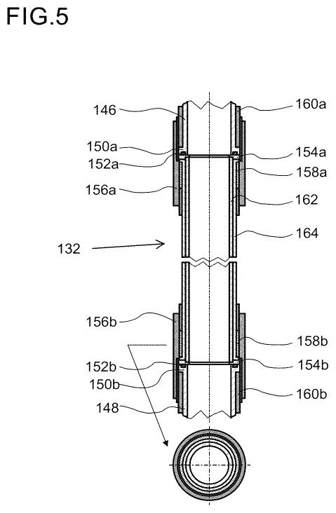

The upper part of FIG. 5 shows a schematic longitudinal section through an example of a connection of two pipelines 146,148 using an electrical insulator 132. The lower part of FIG. 5 shows a cross section for this example. For example, the connection may be configured as described in WO 2019/201654A1 .

A first of the pipelines 146 may have been manufactured from a metallic material. For example, the first pipeline 146 may be the product of centrifugal casting. For example, the pipeline 146 may be cylindrical. For example, the first pipeline 146 may have geometric dimensions of 52 mm×5 mm (diameter D×wall thickness s) prior to installation. The first pipeline 146 may have a collar 150a at its connection end, in which there is a circumferential recess that accommodates a sealing element 152a. For example, the recess may contain an inserted annular flat mica seal as sealing element 152a (Klinger milam PSS 300 from Rich. Klinger Dichtungstechnik Gmbh & Co. KG, 82352 Gumpoldskirchen, Austria).

A second of the pipelines 148 may have been manufactured from a metallic material. For example, the first pipeline 148 may be the product of centrifugal casting. For example, the pipeline 148 may be cylindrical. For example, the second pipeline 148 may have geometric dimensions of 52 mm×5 mm (diameter D x wall thickness s) prior to installation. The second pipeline 148 may have a collar 150b at its connection end, in which there is a circumferential recess that accommodates a sealing element 152b. For example, the recess may contain an inserted annular flat mica seal as sealing element 152a (Klinger milam PSS 300 from Rich. Klinger Dichtungstechnik GmbH & Co. KG, 82352 Gumpoldskirchen, Austria).

The electrical insulator 132 may be configured as a hybrid pipe having a ceramic inner layer and an outer layer of an oxide-ceramic fiber composite. The electrical insulator 132 may have an inner layer, for example, of monolithic ceramic, aluminum oxide (Alsint 99.7 from Morgan Advanced Materials). For example, the inner layer of the electrical insulator may have geometric dimensions of 48 mm×3 mm (diameter D×wall thickness s). The electrical insulator 132 may have an outer layer 164, for example OCMC reinforcement. The reinforcement comprises a ceramic matrix, for example WPS FW12 from Walter E. C. Pritzkow Spezialkeramik (70794 Filderstadt-Sielmingen), and as fiber framework a weave, for example, of the DF11 type from 3M (St. Paul, MN, U.S.A.), for example with geometric dimensions of 52 mm×2 mm (diameter D×wall thickness s). The connection ends of the electrical insulator may each have a collar 154a and 154b. The collars 154a and 154b may have been manufactured from monolithic ceramics, for example aluminum oxide (Alsint 99.7 from Halden-wanger). The collars 154a and 154b, for example, as shown in FIG. 5, may have been manufactured as separate components and cohesively bonded to the inner layer of the electrical insulator. The connection may be established, for example, by a glass solder or by a ceramic adhesive. The collars 154a and 154b may be surrounded by and fixedly bonded to the outer layer 164 of the electrical insulator 132.

The connecting elements between the electrical insulator 132 and the connected pipelines 146 and 148 may be of multipart configuration. The connecting elements may be of identical design on both sides. A connecting element may comprise a clamp sleeve 156a or 156b, a contact pressure element 160a or 160b on the side of the connected pipelines 146 and 148, and a compensating element 158a or 158b. The clamp sleeves 156a and 156b may have been manufactured, for example, from a nickel-base alloy with materials number 2.4633. The contact pressure elements 160a and 160b may have been manufactured, for example, from a nickel-base alloy with materials number 2.4633. The compensating elements 158a and 158b may have been manufactured, for example, from a steel with materials number 1.4876. The connecting elements press the collars 154a or 154b of the electrical insulator and the collars 150a or 150b of the connected pipeline 146 or 148 against one another. In this way, a sealing connection can be established between the electrical insulator 132 and the two connected pipelines 146 and 148. This has the advantage that the sealing faces are subject to axial pressure, which is a favorable type of stress, especially for ceramic materials.

### LIST OF REFERENCE NUMERALS

110 apparatus
112 plant
114 pipeline
116 first end
118 second end
120 supplying pipeline
122 discharging pipeline
124 process direction
126 power source and/or voltage source
128 temperature sensor
130 control unit
132 electrical insulator
134 electrical connections
136 power supply module
138 voltage adjuster
140 medium or high mains input voltage
142 switchgear
144 supply voltage/current
146 first pipeline
148 second pipeline
150 (sealing) collar on the pipeline side
152 sealing element
154 (sealing) collar on the electrical insulator side
156 tensioning element
158 compensating element
160 contact pressure element

1.-15. (canceled)

16. An apparatus for heating a feedstock, wherein the apparatus comprises a plurality of electrically conductive pipelines for accommodating the feedstock, wherein the pipelines are arranged so as to enable parallel feedstock flow, wherein the apparatus includes at least one power source or voltage source set up to supply an electrical current to the pipelines which heats the pipelines by Joule heat which arises as the electrical current passes through conductive pipe material, in order to heat the feedstock, wherein each of the pipelines has a first end and a second end, wherein at least one electrical insulator is disposed at the first end and the second end such that the respective pipeline and at least one supplying pipeline and at least one discharging pipeline are galvanically isolated from one another, wherein the individual pipelines are electrically interconnected in a series connection.

17. The apparatus according to claim 16, wherein the apparatus is set up to heat the feedstock to a temperature in the range from 200° C. to 1700° C.

18. The apparatus according to claim 16, wherein the apparatus has at least one temperature sensor set up to determine a temperature of at least one of the pipelines, where the apparatus has at least one control unit set up to control the power source or voltage source by closed-loop control as a function of a temperature measured by the temperature sensor or an equivalent measurement parameter.

19. The apparatus according to claim 16, wherein the power source or voltage source comprises a single-phase or multiphase AC power source or a single-phase or multiphase AC voltage source, or a DC power source or DC voltage source.

20. The apparatus according to claim 16, wherein the electrical insulator includes at least one material selected from the group consisting of ceramic materials, vitreous materials, glass fiber-reinforced materials, plastic like materials or resinous materials.

21. The apparatus according claim 20, wherein the electrical insulator has a minimum resistance of 100 kΩ to 1000 MΩ.

22. The apparatus according to claim 16, wherein the pipelines are fluidically connected to the supplying and discharging pipelines.

23. The apparatus according to claim 16, wherein the pipelines are through-connected and thus form a pipe system for accommodating the feedstock, or wherein the pipelines are in a mutually fluidically separated configuration.

24. The apparatus according to claim 16, wherein the feedstock is a hydrocarbon to be subjected to thermal cleavage or a mixture.

25. A plant comprising at least one apparatus according to claim 16 and at least one power supply module, wherein the power supply module has at least one voltage adjuster set up to transform a medium or high mains input voltage corresponding to the power requirement to an output voltage usable by the apparatus and to provide the power source or voltage source.

26. The plant according to claim 25, wherein the system comprises a plurality of apparatuses.

27. The plant according to claim 26, wherein the apparatuses are electrically interconnected to one another in series or parallel.

28. The plant according to claim 25, wherein each apparatus has a dedicated power supply module.

29. The plant according to claim 16, wherein the power supply module has a height h of 2 m≥h≥5 m, a width b of 4 m≥b≥7 m and a depth t of 2 m≥t≥5 m.

30. The plant according to claim 16, wherein the plant is selected from the group consisting of: a plant for performance of at least one endothermic reaction, a plant for heating, a plant for preheating, a steamcracker, a steam reformer, an apparatus for alkane dehydrogenation, a reformer, an apparatus for dry reforming, an apparatus for styrene production, an apparatus for ethylbenzene dehydrogenation, an apparatus for cracking of ureas, isocyanates, melamine, a cracker, a catalytic cracker, an apparatus for dehydrogenation, an apparatus for acetylene production from hydrocarbons.
